(19) United States
(12) Patent Application Publication
(10) Pub. No.: US 2024/0353674 A1
(43) Pub. Date: Oct. 24, 2024

(54) ACTIVE OPA MOTION FOR LARGER FOV AND MOTION COMPENSATION

(71) Applicant: X DEVELOPMENT LLC, Mountain View, CA (US)

(72) Inventors: Paul Csonka, Sunnyvale, CA (US); Andrei Kazmierski, Pleasanton, CA (US)

(21) Appl. No.: 18/613,418

(22) Filed: Mar. 22, 2024

Related U.S. Application Data
(60) Provisional application No. 63/460,648, filed on Apr. 20, 2023.

(51) Int. Cl. G02B 26/10; H04B 10/112

(52) U.S. Cl. CPC G02B 26/103; H04B 10/1129

(57) ABSTRACT

Aspects of the disclosure provide a system comprising a first optical communications terminal. The first optical communications terminal comprising a telescope comprising one or more lenses; a movable photonics integrated circuit (PIC) assembly positioned relative to the telescope comprising an optical phased array (OPA); and one or more processors configured to move the moveable PIC assembly; wherein the moveable PIC assembly is configured to move by at least one of i) rotating, or ii) moving along a path, and iii) moving closer to or further from a telescope of the first optical communications terminal.

### CROSS-REFERENCE TO RELATED APPLICATIONS

This application claims the benefit of the filing date of U.S. Provisional Application No. 63/460,648, filed Apr. 20, 2023, the entire disclosure of which is incorporated by reference herein.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., MEMS or voice-coil based fast-steering mirror mechanisms) that are actuated to steer the beam. In other implementations, electro-optic steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electro-optic phase shifting capability.

### BRIEF SUMMARY

Aspects of the disclosure provide a system, the system comprising a first optical communications terminal. The first optical communications terminal comprising a telescope comprising one or more lenses; a movable photonics integrated circuit (PIC) assembly positioned relative to the telescope comprising an optical phased array (OPA); and one or more processors configured to move the movable PIC assembly; herein the moveable PIC assembly is configured to move by at least one of i) rotating, or ii) moving along a path, and iii) moving closer to or further from a telescope of the first optical communications terminal.

In one example, the first optical communications terminal further includes one or more magnets coupled to the movable PIC assembly. In an additional example, the first optical communications terminal further includes a surface, the surface configured to be selectively magnetized.

In one example, the first optical communications terminal further includes one or more actuators coupled to the movable PIC assembly; and a movable component coupled to the movable PIC assembly and configured to allow for movement of the movable PIC assembly. In an additional example, the movable PIC assembly is configured to move about the movable component. Additionally or alternatively, the one or more actuators are a first actuator and a second actuator and the first actuator is disposed on an edge of the movable PIC assembly opposite the second actuator. Additionally or alternatively, the movable component may be used in conjunction with a movable component actuator and the one or more actuators move faster than the movable component actuator. Additionally or alternatively, the first optical communications terminal further comprises an arm structure, the arm structure coupled to the movable PIC assembly and the movable component such that the arm structure is arranged perpendicular or approximately perpendicular to the movable PIC assembly.

In one example, the system further includes a second optical communications terminal.

In an additional example, the first optical communications terminal further includes one or more heat straps coupled to the movable PIC assembly and wherein the one or more heat straps have an elasticity such that the movable PIC assembly may move within an expected performance envelope.

In another example, the movable PIC assembly further includes a thermal base configured to evenly distribute heat away from the movable PIC assembly.

In an additional example, the first optical communications terminal further includes a cable.

In a further example, the telescope is a Keplerian telescope.

In another example, the telescope is a Galilean telescope.

In one example, the movable PIC assembly is positioned at a plane relative to the telescope and wherein the plane is an exit pupil of the telescope.

Another aspect of the disclosure provides a method of moving a movable photonics integrated circuit (PIC) assembly comprising an optical phased array (OPA) of a first optical communications terminal. The method comprising actuating, by one or more processors, the movable PIC assembly using at least one of i) a contact connection, or ii) a non-contact connection; and moving the movable PIC assembly due to the actuating; wherein the moving is at least one of i) rotating, ii) moving along a path, and iii) moving closer to or further from a telescope of the first optical communications terminal.

In one example the moving is rotating; and the moving includes displacing a center of the movable PIC assembly by an angle and a distance.

In another example the moving is rotating; and the moving does not include displacing a center of the movable PIC assembly.

In a further example the moving is moving along the path, wherein the path is an arc-shaped path; and the arc-shaped path forms a portion of a circumference of a circle. Additionally or alternatively, a center of the circle is a center of a movable component.

In one example, the moving is moving along the path, wherein the path is a bowl-shaped path; and the bowl-shaped path forms a portion of a sphere. Additionally or alternatively, a center of the sphere is a center of a movable component.

In another example, the moving is moving closer to or further from the telescope of the first optical communications terminal; and the moving is along an optical axis of the telescope of the first optical communications terminal.

In an additional example, the moving is about a movable component.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communication terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 illustrates an example configuration in accordance with aspects of the disclosure.

FIG. 6 illustrates an example configuration in accordance with aspects of the disclosure.

FIG. 7 is an example configuration in accordance with aspects of the disclosure.

FIG. 8 is an example configuration in accordance with aspects of the disclosure.

FIG. 9 is an example configuration in accordance with aspects of the disclosure.

FIG. 10 is an example configuration in accordance with aspects of the disclosure.

FIG. 11 is an example configuration in accordance with aspects of the disclosure.

FIG. 12 illustrates an example system in accordance with aspects of the disclosure.

FIG. 13 illustrates an example system in accordance with aspects of the disclosure.

FIG. 14 illustrates an example system in accordance with aspects of the disclosure.

FIG. 15 illustrates an example system in accordance with aspects of the disclosure.

FIG. 16 illustrates an example system in accordance with aspects of the disclosure.

FIG. 17 illustrates an example method with aspects of the disclosure.

FIG. 18 illustrates an example method with aspects of the disclosure.

### DETAILED DESCRIPTION

### Overview

The technology relates to an optical phased array (OPA) architecture for an optical communications terminal with a configurable field of view (FOV; the immediate detection and transmission cone) which results in an overall larger field of regard (FOR; the overall reachable detection and transmission cone). The OPA architecture may involve the use of a movable Photonics Integrated Circuit (PIC) containing an OPA. This architecture may enable a wider FOV and FOR for an optical communications terminal than typical configurations.

For instance, generally, to increase the FOV and FOR of an optical communications terminal, a more complex and/or larger device may be required. For example, to achieve a larger FOV which also results in a larger FOR, an optical communications terminal may utilize larger optics (e.g., larger lenses and/or telescope), smaller emitter size or tighter pitch, and a larger number of elements (e.g., array elements, phase shifters) within the OPA. In this regard, the optics, emitter, pitch, and elements are balanced to maintain a main lobe of an optical communications beam within a desired divergence range. However, such approaches may be complex and costly to develop and manufacture. Other approaches to increasing the FOR, such as utilizing steering elements like mirrors or prisms, may be costly, require more physical volume, alignment of additional components during manufacturing, or cause beam dispersion and/or dissipation due to an additional reflecting surface or transmission medium. As such, even removing cost and complexity, a higher power beam is needed to maintain connectivity and connection quality.

To address this, as noted above, a first optical communications terminal may implement movable PIC assembly containing an OPA allowing for a wider FOR. In this regard, the FOR may be increased without higher power requirements, without significant additional physical volume requirements, a more costly or complex OPA device, more costly or complex optical components, or more complex and costly manufacturing processes.

As noted above, the OPA architecture for a first optical communications terminal may involve a movable PIC assembly. The movable PIC assembly includes the OPA architecture. The movable PIC assembly may include additional components such as an application-specific integrated circuit (ASIC), one or more microlenses or microlens arrays, etc. The first optical communications terminal may include components to support communication functionality. For example, the first optical communications terminal may include one or more lenses that form a telescope. The telescope may receive collimated light and output collimated light. The telescope may include an objective portion, an eyepiece portion, and a relay portion. The movable PIC assembly may be placed a distance from the one or more lenses of the telescope and may be moved relative to one or more lenses of the telescope.

The movable PIC assembly may include a thermal base. The thermal base may be configured to evenly distribute heat away from the movable PIC assembly. One or more heat straps may be disposed on the movable PIC assembly to transfer heat away from the thermal base, the movable PIC assembly. A cable (e.g., a flex cable) may be connected to the movable PIC assembly. The cable may allow for communication between the movable PIC assembly and OPA with other portions of the first optical communications terminal. Additionally or alternatively, the cable may include an optical fiber connection (e.g., laser, avalanche photodiodes (APD)). The optical fiber connection may allow for communication between the movable PIC assembly and OPA with other portions of the first optical communications terminal. A movable component (e.g., gimbal, ball flexure point, pivot, flexure pivot, etc.) may be connected to the movable PIC assembly. In some implementations, the movable component may form a gimbal. In one example, the gimbal may be a pivoted support gimbal. In another example, the movable component may be a flexure pivot and connected to a gimbal ring. In some implementations, an arm structure may connect the movable component to the movable PIC assembly. One or more actuators may be connected to the movable PIC assembly.

In some implementations, at least one of i) the movable component and ii) the one or more actuators may allow for movement of the movable PIC assembly. In some instances, the movable PIC assembly may be configured to rotate. In addition or alternatively, the movable PIC assembly may be configured to move along a path (e.g., an arc-shaped path, a bowl-shaped path, or an arbitrary path). Additionally or alternatively, the movable PIC assembly may be moved with respect to the telescope of the first optical communications terminal (e.g., closer too, further from, etc.).

Additionally, or alternatively, in some implementations, the movable PIC assembly may be moved via a non-contact method (e.g., magnetic connection, electrostatic connection, etc.). In one example, one or more magnets (e.g. coils) may be connected to or part of the movable PIC assembly. In this regard, the movement of the movable PIC assembly may be controlled by a magnetic field. The magnetic field may be configured to change thereby causing the movement of the movable PIC assembly. Additionally or alternatively, the movable PIC assembly may be disposed adjacent to a surface. The surface, the movable PIC assembly, or both may be able to be selectively magnetized. The one or more magnets (e.g., coils) and one or more magnets (e.g. coils) of the surface may allow for the selective magnetizing. In this regard, the selective magnetizing of the surface, the movable PIC assembly, or both may allow the movable PIC assembly to move with respect to the surface. Additionally or alternatively one or more additional magnets (e.g. coils) may be disposed adjacent to the movable PIC assembly. The one or more additional magnets may be selectively magnetized via the one or more processors to allow for movement of the movable PIC assembly.

When transmitting and receiving optical communications beams, the first optical communications terminal 102 may be aligned with one or more remote optical communications terminals. To align the FOV with one or more remote optical communications terminals, the movable PIC assembly of the first optical communications terminal 102 may be moved and/or rotated. In this regard, the OPA of the movable PIC assembly may be configured to transmit and receive optical communications beams.

The movable photonics integrated circuit (PIC) assembly comprising an optical phased array (OPA) of a first optical communications terminal may be moved. The movable OPA may be moved by actuating, by one or more processors, the movable PIC assembly using at least one of i) a contact connection, or ii) a non-contact connection. In one instance, the actuating may use a contact connection. In this regard, the actuating may include actuating, by one or more processors, a movable component. Additionally or alternatively, the actuating may include actuating, by one or more processors, one or more actuators. Additionally or alternatively, in one instance, the actuating may use a non-contact connection. In this regard, the actuating may include changing a magnetic field. Additionally or alternatively, the actuating may include changing an electrostatic field. The moving of the movable PIC assembly may be due to the actuating. In some implementations, the moveable PIC assembly may be moved about the movable component due to the actuating. In this regard, the one or more actuators and/or the movable component coupled to the movable PIC assembly may be actuated. The actuation may allow for the movement of the movable PIC assembly. Additionally or alternatively, the movement of the movable PIC assembly may be moved with respect to a surface due to the selective magnetizing of the surface, the movable PIC assembly, or both.

The moving may be one at least one of i) rotating, ii) moving along a path, and iii) moving closer to or further from a telescope of the first optical communications terminal. In one example, the movable PIC assembly may be rotated such that the first optical communications terminal may transmit and receive one or more optical communications beams with the one or more remote optical communications terminals. In some instances, the moving may include rotating the movable PIC assembly about the movable component (e.g., one or more axes of the movable component). In some instances, the movement of the movable PIC assembly may be in the x and y planes. The rotation of the movable PIC assembly may be such that the FOV of the first optical communications terminal differs at each position. In one instance, the rotation of the movable PIC assembly may be such that the center of the movable PIC assembly is not displaced when rotated. In another instance, the rotation of the movable PIC assembly may be such that the center of the movable PIC assembly is displaced by an angle and a distance during rotation

In another example, the movable PIC assembly may move along a path of a particular shape such that the first optical communications terminal may transmit and receive one or more optical communications beams with the one or more remote optical communications terminals. In this regard, during actuation, the movable PIC assembly may be moved along the path about the movable component. In some instances, the path may be an arc-shaped path which may form a portion of the circumference of a circle. In one example, the center of the circle may be the center of the movable component. In another instance, the path may be a bowl-shaped path which may form a portion of a sphere. In one example, the center of the sphere may be the center of the movable component.

Additionally or alternatively, the movable PIC assembly may be moved with respect to the telescope of the first optical communications terminal (e.g., closer too, further from, etc.). In some implementations, the movable PIC assembly may be moved along an optical axis of the telescope of the first optical communications terminal. The movable PIC assembly may be moved to change a beam divergence (e.g., optical communications beam divergence) of the first optical communications terminal. This may be used for easier acquisition, higher tracking performance during large disturbances, etc.

The features and methodology described herein may provide a communication system containing optical communications terminals with a configurable FOV. The configurable FOVs may allow an optical communications terminal to be aligned with one or more remote optical communications terminals across a larger FOR. In this regard, such communication systems require less materials to construct and are easier to maintain overall. Additionally, the individual optical communications terminals may require fewer precision surfaces (e.g., may not require an internal steering mirror). In this regard, the internal components of the optical communications terminal may require less actuation overall to allow for a desired bandwidth. Moreover, as an optical communications beam may be directed from the telescope to movable PIC assembly without other precision surfaces, the architecture reduces dispersion and/or dissipation. As such, a narrower beam with lower power and less volume may be used to maintain connectivity and connection quality. Such a design allows for less complexity and fewer materials.

### Example Systems

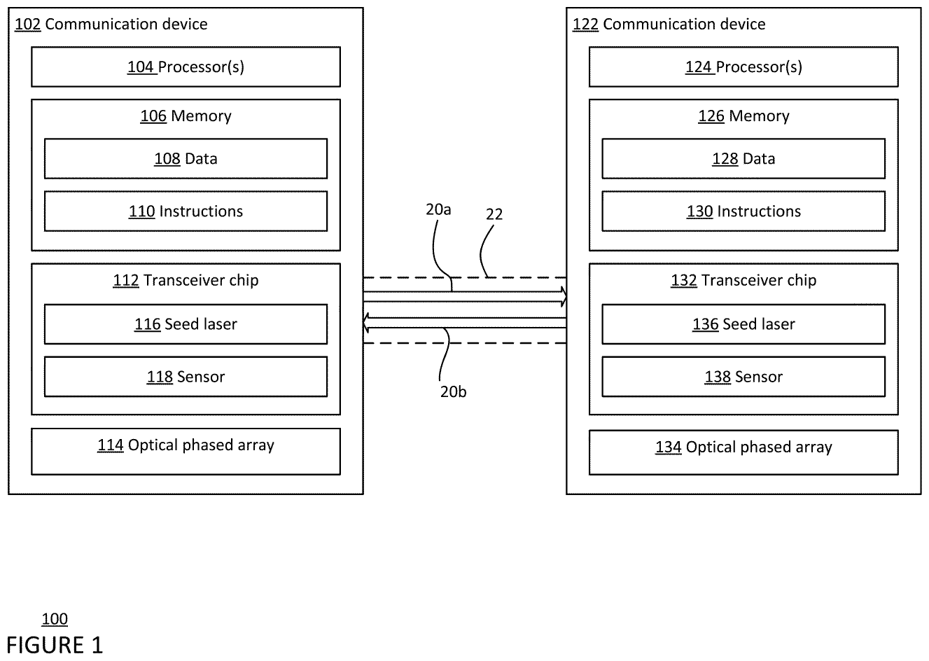

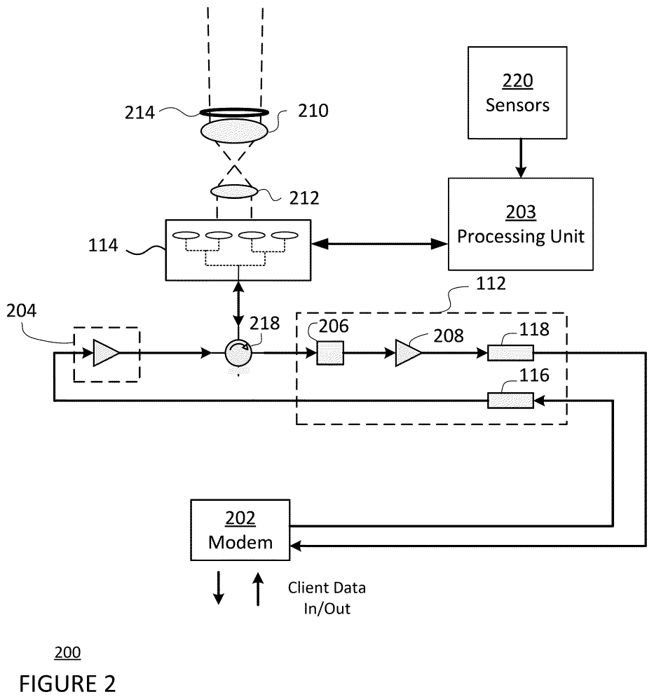

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the communications terminal. For case of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

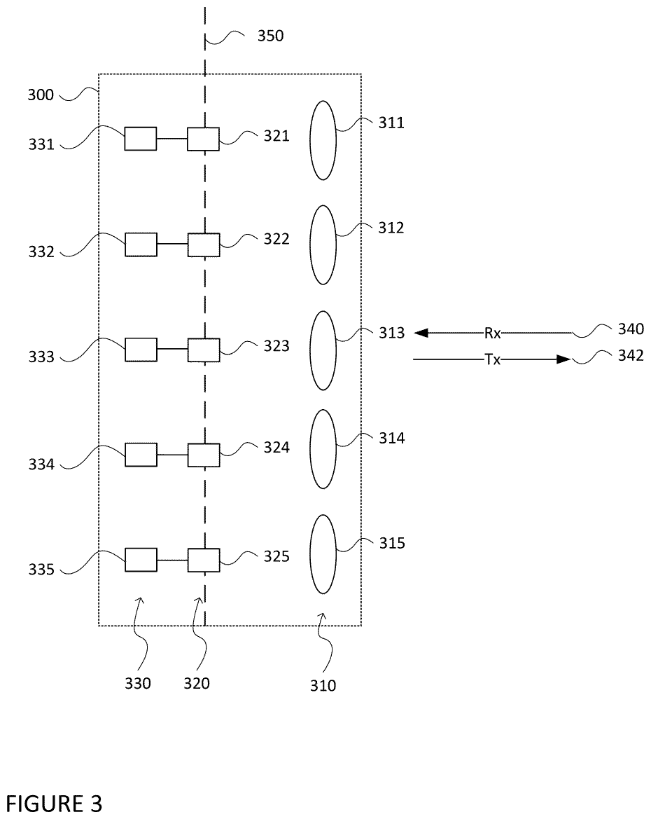

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 100's of micrometers in diameter and height. In addition, each micro-lens of the micro-lens array may be manufactured by molding, printing, or etching a lens directly into a wafer of the OPA chip 300. Alternatively, the micro-lens array 310 may be molded as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (e.g., edge length of a micro-lens edge length) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

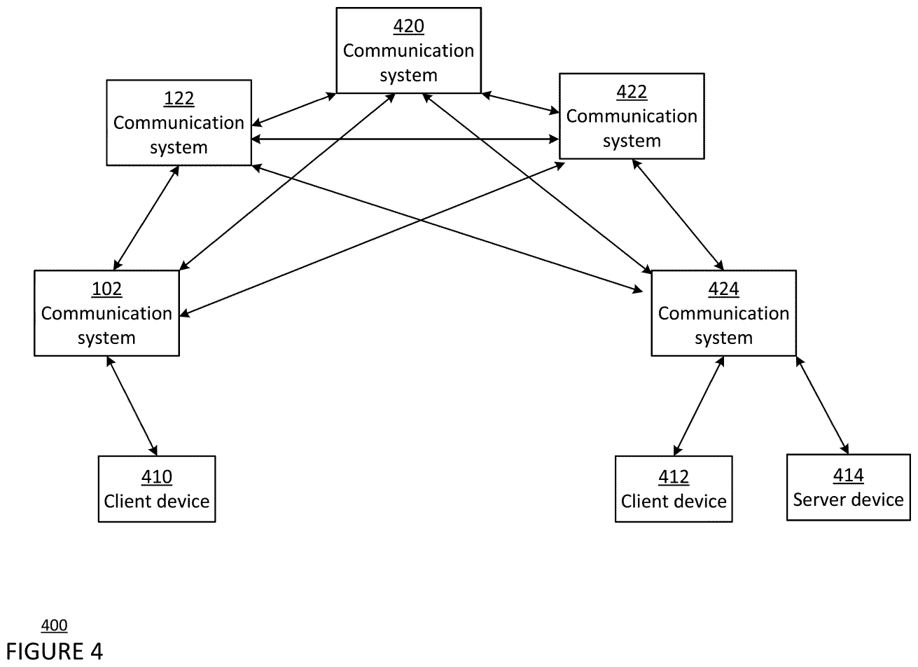

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of movable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

As noted above, the OPA architecture for a first optical communications terminal may involve a movable PIC assembly. The movable PIC assembly may include the OPA architecture. The movable PIC assembly may include additional components such as an application-specific integrated circuit (ASIC), one or more microlenses or microlens arrays, etc. The first optical communications terminal may include components to support communication functionality. For example, the first optical communications terminal 102 may include one or more lenses that form a telescope. The telescope may receive collimated light and output collimated light. The telescope may include an objective portion, an eyepiece portion, and a relay portion. The movable PIC assembly may be placed a distance from the one or more lenses of the telescope and may be moved relative to one or more lenses of the telescope.

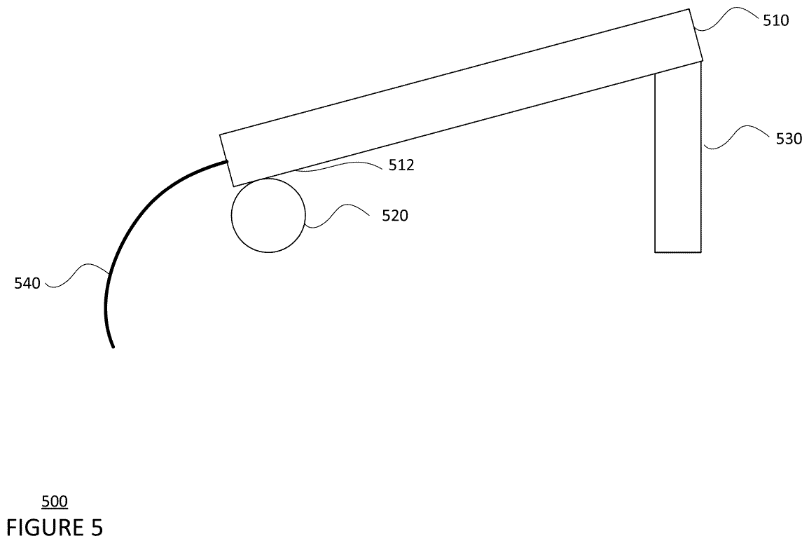

FIG. 5 illustrates an example configuration 500 containing the movable PIC assembly 510. The example configuration 500 includes the movable PIC assembly 510, a movable component 520 (e.g., gimbal, ball flexure point, pivot, flexure pivot etc.) coupled to the movable PIC assembly 510, one or more actuators 530 coupled to the movable PIC assembly 510, and a cable 540 (e.g., a flex cable) coupled to the movable PIC assembly 510. In some instances, the movable component 520 may be coupled to an edge 512 of the movable PIC assembly 510. The movable component 520 may be constructed of spring steel or other materials. In some instances, the movable component 520 may be a flexure component configured to bend and flex. Additionally or alternatively, the movable component 520 may be a joint, ball and spring, or other mechanical non-flexure connection. Additionally or alternatively, the movable component 520 may form a gimbal. In one example, the gimbal may be a pivoted support gimbal. In another example, the movable component may be a flexure pivot and connected to a gimbal ring. Additionally or alternatively, the movable component 520 may be configured to distribute heat away from the movable PIC assembly. In some instances, the one or more actuators 530 may each be coupled to an edge 512 of the movable PIC assembly 510. The one or more actuators 530 may be voice coil actuators (VCM). The cable 540 may allow for communication between the movable PIC assembly and OPA with other portions of the first optical communications terminal 102. For example, the cable 540 may contain one or more optical fibers that may connect to the movable PIC assembly optical transmitter (e.g. laser and silicon optical amplifier) and/or optical detector (e.g. avalanche photodiode).

In some instances, the one or more actuators 530 may move faster than the movable component 520. Additionally or alternatively, the movable component 520 could also be used in conjunction with a movable component actuator. In this regard, the movable component 520 may be used to move the movable PIC assembly 510 with respect to the telescope of the first optical communications terminal (e.g., closer too, further from, etc.). In this regard, the beam divergence (e.g., optical communications beam divergence) may be modified by adjusting a position of the movable PIC assembly 510 (e.g., distance of the movable PIC assembly with respect to the one or more of the lenses of the telescope).

In some instances, the one or more actuators 530 may be a plurality of actuators. In such an instance, the plurality of actuators may be disposed on the corners of the movable PIC assembly 510 in a push/pull configuration. Such a configuration may function in the same manner as a 6-axis kinematic hexapod (e.g., push/pull allowing for movement of the movable PIC assembly 510).

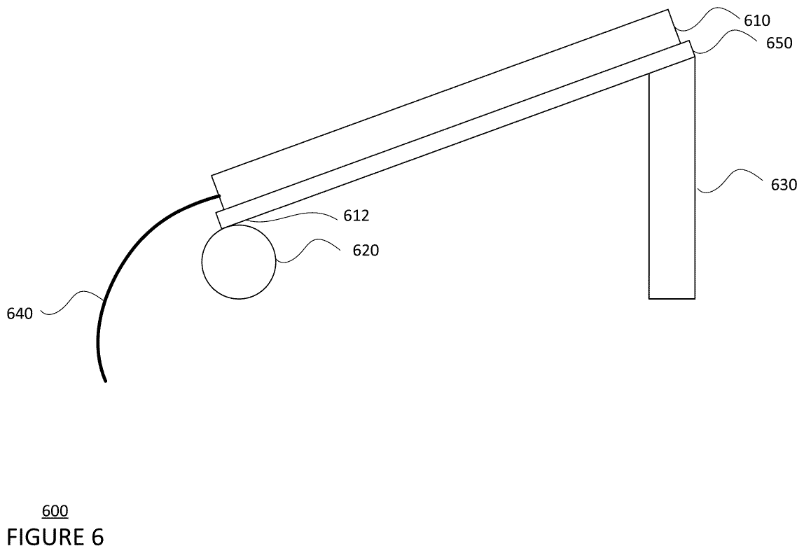

In some instances, the movable PIC assembly may include a thermal base. In this regard, FIG. 6 illustrates an example configuration 600 containing the movable PIC assembly 610 which includes thermal base 650. The example configuration includes movable PIC assembly 610, a movable component 620 (e.g., gimbal, ball flexure point, pivot, flexure pivot, etc.) coupled to the movable PIC assembly 610, one or more actuators 630 coupled to the movable PIC assembly 610, and a cable 640 (e.g., a flex cable) coupled to the movable PIC assembly 610. In such an instance, the movable component 620 and the one or more actuators 630 is coupled to the thermal base 650 of the movable PIC assembly as illustrated in FIG. 6. In this regard, the movable component 620 may be connected to an edge 612 of the thermal base 650. Additionally or alternatively, the one or more actuators 630 may each be coupled to an edge 612 of the thermal base 650.

The thermal base 650 may be configured to evenly distribute heat away from the movable PIC assembly 610, or include an active or passive cooling element (e.g., TEC or heat sink), or an interface to an active or passive cooling element (e.g., heat pipe). The thermal base 650 and/or active or passive cooling elements or cooling interfaces may be constructed of a material capable of or suitable for distributing heat and withstanding the movement of the movable PIC assembly 610 (e.g., copper, aluminum, aluminum nitride, silicon, etc.). The heat may be produced as a result of the transmission and receipt of optical communications beams.

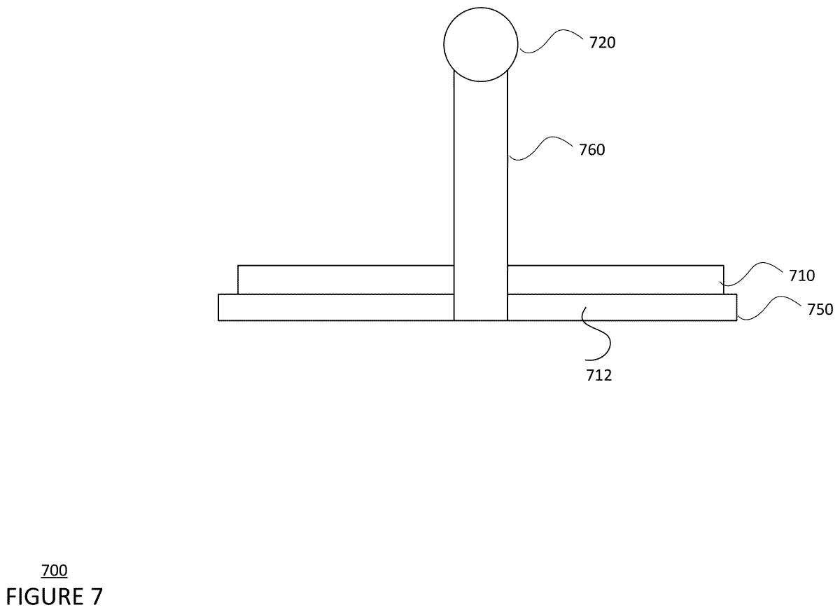

In some implementations, an arm structure may connect the movable component to the movable PIC assembly. In this regard, FIG. 7 illustrates an example configuration 700 where an arm structure 760 is coupled to the movable component 720 and the movable PIC assembly 710. In such an example, the movable component 720 may be coupled to a first end of the arm structure 760 and an edge 712 of the movable PIC assembly 610 may be coupled to a second end of the arm structure 760. Additionally or alternatively, the arm structure 760 may be arranged perpendicular or approximately perpendicular to the movable PIC assembly 710. In the example illustrated in FIG. 7, the movable PIC assembly 710 contains thermal base 750. In this example, the arm structure is coupled to the thermal base 750 of the movable PIC assembly 710. In alternative implementations containing an arm structure, a thermal base may not be included. In some implementations, one or more actuators may be coupled to arm structure 760 to allow for movement of the movable PIC assembly 710. Additionally or alternatively one or more actuators may be coupled to the movable PIC assembly 710 to allow for movement thereof. Additionally or alternatively, the one or more actuators may be a plurality of actuators. In such an instance, the plurality of actuators may be disposed on the corners of the movable PIC assembly 710 in a push/pull configuration. Such a configuration may function in the same manner as a 6-axis kinematic hexapod (e.g., push/pull allowing for movement of the movable PIC assembly 710).

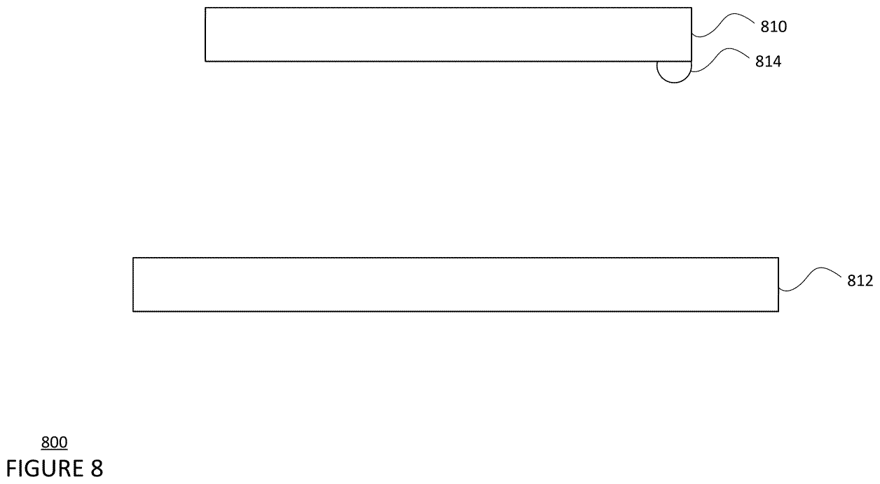

Additionally, or alternatively, in some implementations, the movable PIC assembly may be moved via a non-contact method (e.g., magnetic connection, electrostatic connection, etc.). In such implementations, one or more magnets may be connected to or part of the movable PIC assembly. The movable PIC assembly and the one or more magnets may be in a magnetic field. In this regard, the magnetic field may be configured to change thereby causing the movement of the movable PIC assembly. Changing the magnetic field may include activating the magnetic field, deactivating the magnetic, and/or changing the strength or direction of the magnetic field. Additionally or alternatively, the movable PIC assembly may be disposed adjacent to a surface. The surface, the movable PIC assembly, or both may be able to be selectively magnetized via the one or more magnets (e.g., coils). The selective magnetizing may be controlled via the one or more processors. In this regard, the surface, the movable PIC assembly, or both may be selectively magnetized (e.g., selectively produce a magnetic field). The one or more magnets (e.g. coils) and one or more magnets (e.g. coils) of the surface may allow for the selective magnetizing. As illustrated in FIG. 8, an example configuration 800 contains movable PIC assembly 810 and surface 812. Movable PIC assembly 810 contains one or more magnets 814. The selective magnetizing of the surface 812, the one or more magnets 814, or both may allow the movable PIC assembly 810 to move with respect to the surface 812. FIG. 8 illustrates movable PIC assembly 810 parallel to surface 812, however movable PIC assembly 810 may be oriented otherwise with respect to surface 812. For example, the movable PIC assembly 810 may be perpendicular with respect to surface 812 or at a different angle with respect to surface 812. Additionally, FIG. 8 illustrates one or more magnets 814 disposed on an edge of the movable PIC assembly 810, however, the one or more magnets may be in differing configurations (e.g., in a thermal base, in the center of the movable PIC assembly 810, along an arm structure of the movable PIC assembly, etc.). Additionally or alternatively one or more additional magnets (e.g. coils) may be disposed adjacent to the movable PIC assembly. The one or more additional magnets may be selectively magnetized via the one or more processors to allow for movement of the movable PIC assembly. In such implementations, the configuration may or may not include a movable component, arm structure, and one or more actuators in addition to other components disclosed above.

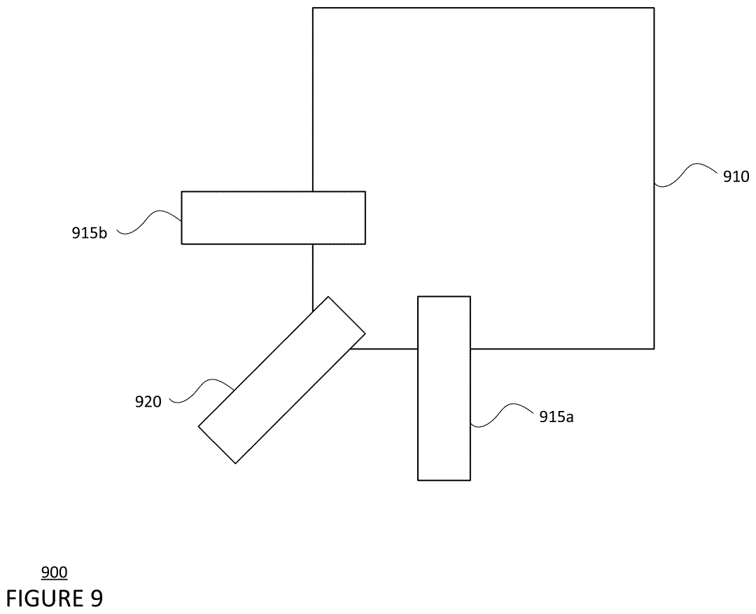

In some implementations one or more heat straps may be disposed on the movable PIC assembly to transfer heat away from the movable PIC assembly. In this regard, FIG. 9 illustrates an example configuration 900 where heat straps 915a, 915b are disposed on the movable PIC assembly. In such an example, the heat straps 915a, 915b are disposed on adjacent edges of the movable PIC assembly 910. The heat straps 915a,915b are each disposed a distance from the movable component 920 as to not overly impede the movement of the movable PIC assembly 910 about the movable component 920. The heat straps may be made of a material configured to transfer heat such as, copper, aluminum, graphene, graphite, aluminum nitride, silicon etc. The heat straps may have an elasticity such that the one or more heat straps do not overly hinder the motion of the movable PIC assembly. In this regard, the elasticity may be such that the movable PIC may move within an expected performance envelope.

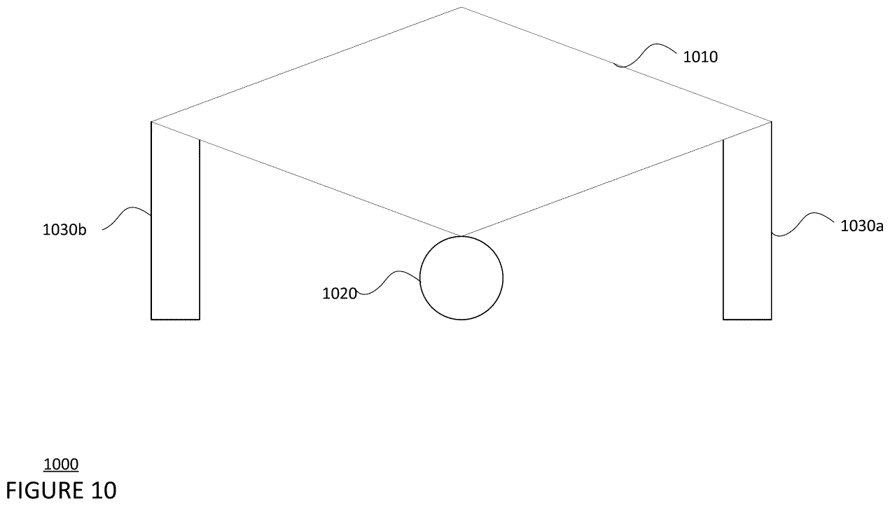

In some instances, the one or more actuators may include a first actuator and a second actuator. In this regard, FIG. 10 illustrates an example configuration 1000 with a first actuator 1030a and a second actuator 1030b are coupled to the movable PIC assembly 1010. In such an instance, the first actuator 1030a and the second actuator 1030b may be disposed on opposite sides or edges of the movable PIC assembly. The first actuator 1030a and the second actuator 1030b may each be disposed a distance from the movable component 1020.

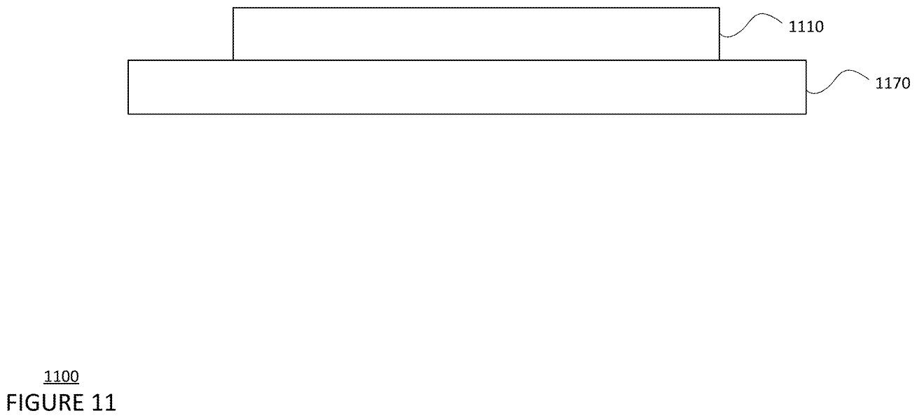

Additionally or alternatively in some instances, the movable PIC assembly may be disposed on a steering mirror. FIG. 11 illustrates an example configuration 1100 where the movable PIC assembly 1110 is disposed on a steering mirror 1170. In this regard, the movable PIC assembly 1110 may be disposed on a steering mirror 1170 previously used to direct an optical communications beam to an OPA. The steering mirror 1170 may contain a mirror and one or more mirror actuators coupled to the mirror. In some implementations they may include one or more coils and one or more magnets.

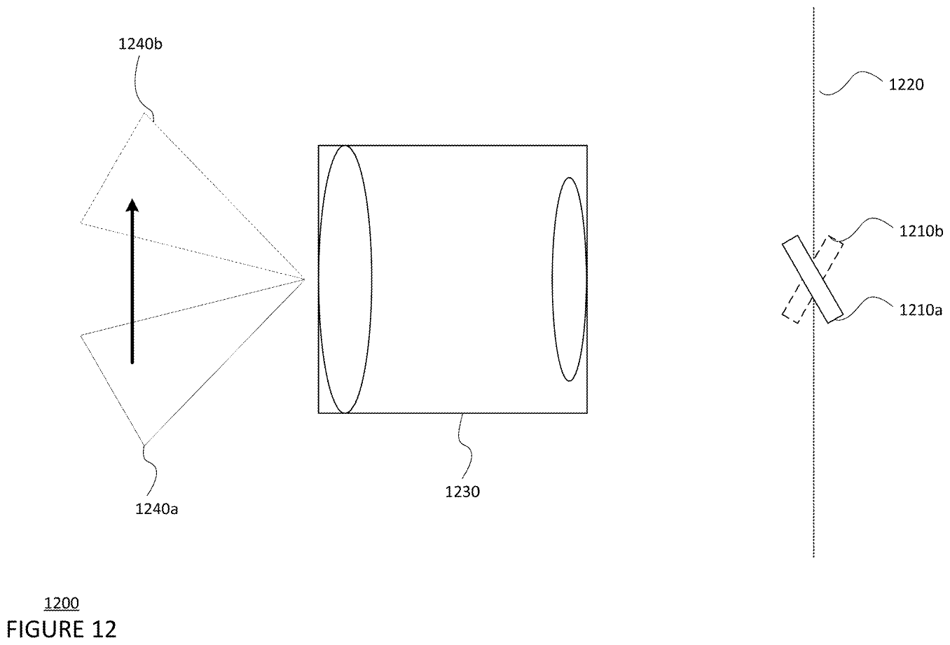

The movable component, such as the movable component 520,620,720,920,1020 and the one or more actuators 530,630,1030a,1030b may allow for movement of the movable PIC assembly. Additionally or alternatively, the one or more magnets 814 and/or the surface 812 may allow for movement of the movable PIC assembly. In some instances, the movable PIC assembly 510,610,810,910,1010 may be configured to rotate. In some examples, the movable PIC assembly 510,610,810,910,1010 may be configured to rotate about the movable component 520,620,920,1020 (e.g., one or more axes of the movable component). In some instances, the movement of the movable PIC assembly may be in the x and y planes. FIG. 12 illustrates one example system 1200 where the movable PIC assembly 1210 is configured to rotate. The movable PIC assembly 1210 may be disposed on a plane 1220 parallel or approximately parallel to the one or more lenses of the telescope 1230. The rotation of the movable PIC assembly 1210 may be such that the FOV 1240 of the first optical communications terminal 102 differs at each position.

FIG. 12 illustrates the movable PIC assembly 1210 at a first position 1210a with a corresponding FOV 1240a and the movable PIC assembly 1210 at a second position 1210b with a corresponding FOV 1240b. The rotation of the movable PIC assembly 1210 illustrated in FIG. 12 is such that the center of the movable PIC assembly 1210 is not displaced when rotated from the first position 1210a to the second position 1210b. FIG. 12 illustrates only a first position 1210a and a second position 1210b of the movable PIC assembly 1210, however, the movable PIC assembly 1210 may be rotated to a plurality of positions with a corresponding plurality of FOVs such that the entire FOR is viewable by the first optical communications terminal 102.

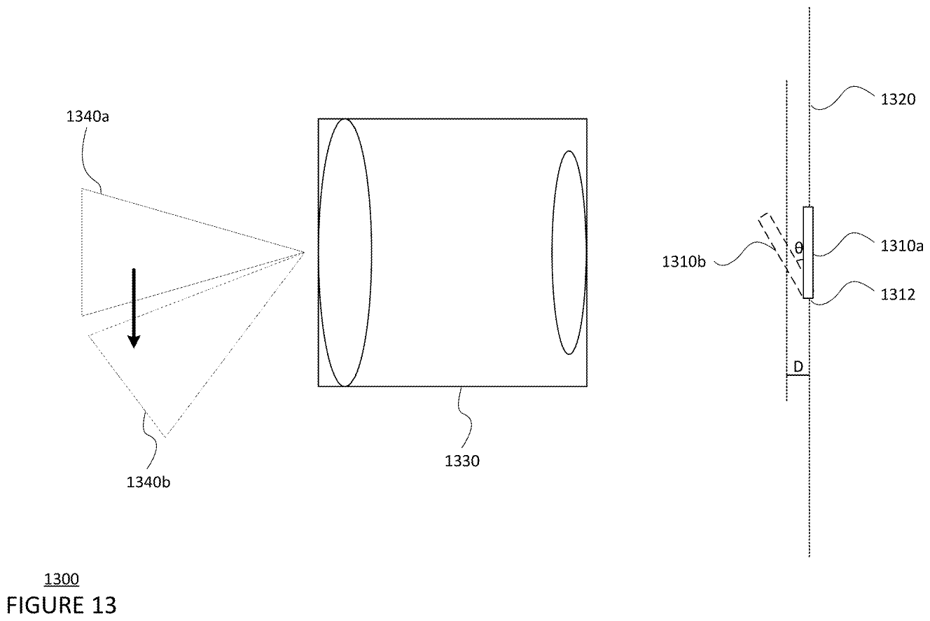

FIG. 13 illustrates one example system 1300 where the movable PIC assembly 1310 is configured to rotate about an edge 1312 thereof. The movable PIC assembly 1310 may be disposed on a plane 1320 parallel or approximately parallel to the one or more lenses of the telescope 1330. The rotation of the movable PIC assembly 1310 may be such that the FOV 1340 of the first optical communications terminal 102 differs at each position. FIG. 13 illustrates the movable PIC assembly 1310 at a first position 1310a with a corresponding FOV 1340a and the movable PIC assembly 1310 at a second position 1310b with a corresponding FOV 1340b. The rotation of the movable PIC assembly 1310 illustrated in FIG. 13 is such that the center of the movable PIC assembly 1310 is displaced by an angle θ and a distance D during rotation from the first position 1310a to the second position 1310b. FIG. 13 illustrates only a first position 1310a and a second position 1310b of the movable PIC assembly 1310, however, the movable PIC assembly 1310 may be rotated to a plurality of positions with a corresponding plurality of FOVs such that the entire FOR is viewable by the first optical communications terminal 102.

In some instances, the movable PIC assembly 710 may be configured to move along a path. In some instances the path may be a plane. The path may be arc-shaped, bowl-shaped or arbitrary-shaped. In some instances the arc and bowl of the arc-shaped plane or path and the bowl-shaped plane or path may be arbitrary. In some examples the movable PIC assembly 710 may be configured to move along a path about the movable component 720 or rather, to move about one or more axes of the movable component.

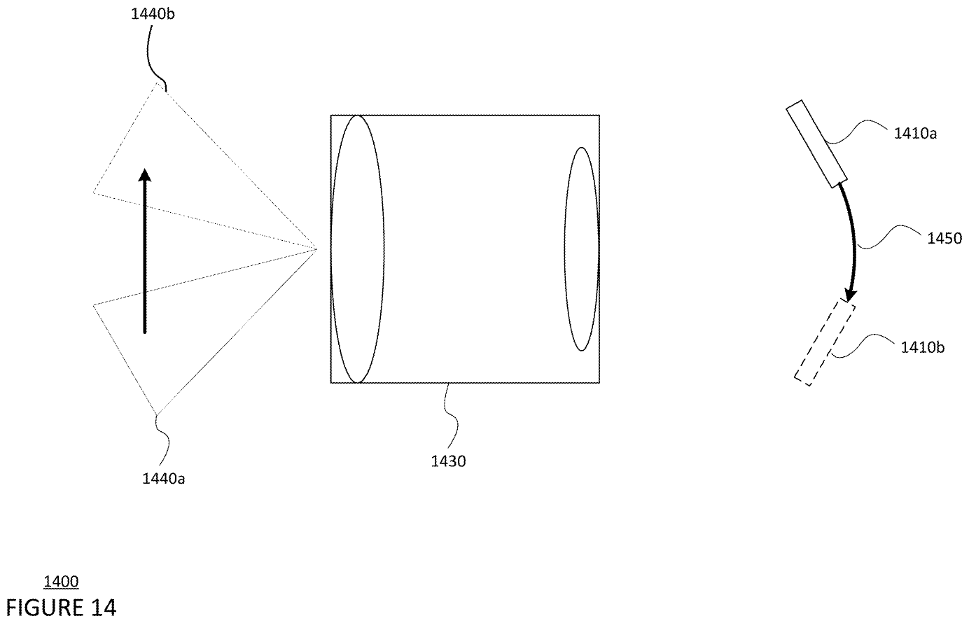

FIG. 14 illustrates one example system 1400 where the movable PIC assembly 1410 is configured to move along an arc-shaped path. The movable PIC assembly 1410 may be disposed a predetermined distance from the telescope 1430. In this regard, the distance may be large enough to avoid mechanical interference. Additionally or alternatively, the distance may be small enough such that the movable PIC assembly 1410 need not be moved unreasonably fast or far to be repositioned (e.g., compensate for a change in the free space angle of light entering the telescope).

The movement of the movable PIC assembly 1410 illustrated in FIG. 14 may be such that the movable PIC assembly 1410 moves along an arc-shaped path 1450. The movement of the movable PIC assembly 1410 may be such that the FOV 1440 of the first optical communications terminal 102 differs at each position. FIG. 14 illustrates the movable PIC assembly 1410 at a first position 1410a with a corresponding FOV 1440a and the movable PIC assembly 1410 at a second position 1410b with a corresponding FOV 1440b. FIG. 14 illustrates only a first position 1410a and a second position 1410b of the movable PIC assembly 1410, however, the movable PIC assembly 1410 may be moved to a plurality of positions along arc-shaped path 1450 with a corresponding plurality of FOVs such that the entire FOR is viewable by the movable PIC assembly 1410.

Additionally or alternatively, in some instances, the movable PIC assembly 510,610,710,810,910,1010 may be moved with respect to the telescope of the first optical communication terminal 102. In some implementations, the movable PIC assembly 510,610,710,810,910,1010 may be moved along an optical axis of the telescope of the first optical communications terminal 102. The movable PIC assembly 510,610,710,810,910 may be moved to change beam divergence (e.g., optical communications beam divergence). In this regard, the movable PIC assembly 510,610,710,810,910,1010 may be moved closer to or further from the telescope. This may be used for easier acquisition, higher tracking performance during large disturbances, etc.

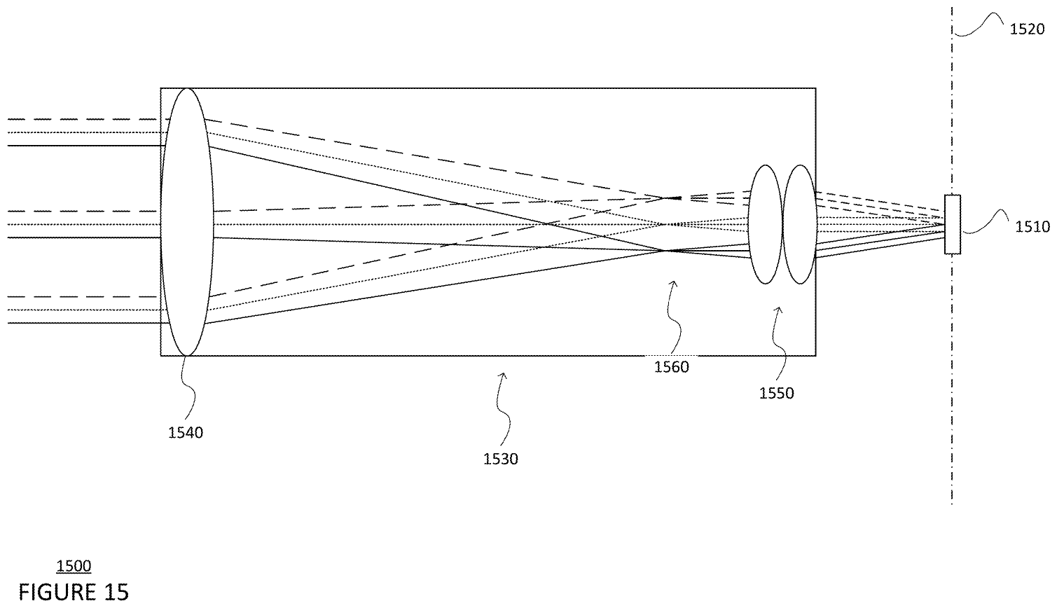

The telescope of the first optical communications terminal 102 may include the one or more lenses and an aperture (or opening) through which light may enter and exit the first optical communications terminal. FIG. 15 illustrates an example system 1500 containing a Keplerian telescope 1530. The Keplerian telescope 1530 includes a first lens 1540 defining an entrance pupil and one or more lenses 1550 between an intermediate focus 1560 and a real exit pupil at plane 1520. In examples where the first optical communications terminal 102 utilizes a Keplerian telescope 1530, the movable PIC assembly 1510 containing the OPA may be placed at the real exit pupil at plane 1520 of the Keplerian telescope 1530.

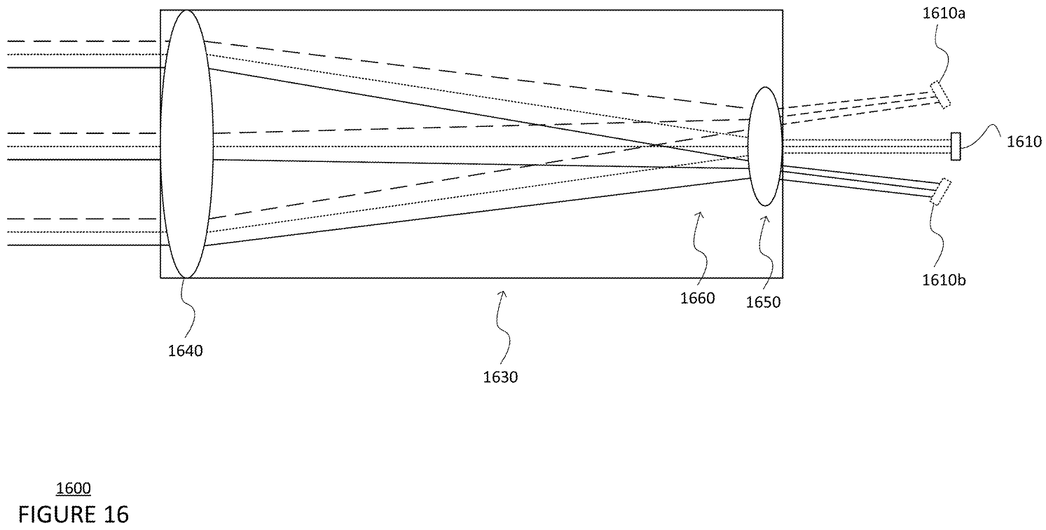

FIG. 16 illustrates an example system 1600 containing a Galilean telescope 1630. The Galilean telescope 1630 includes a first lens 1640 defining an entrance pupil and one or more lenses 1650 following a virtual exit pupil 1660. In examples where the first optical communications terminal 102 utilizes a Galilean telescope 1630, the movable PIC assembly 1610 containing the OPA may be placed at a distance from the Galilean telescope 1630. In this regard, the distance may be large enough to avoid mechanical interference. Additionally or alternatively, the distance may be small enough such that the movable PIC assembly 1610 need not be moved unreasonably fast or far to be repositioned (e.g., compensate for a change in the free space angle of light entering the Galilean telescope). Positions 1610a, 1610b illustrate additional or alternative positions of the movable PIC assembly 1610.

Additionally or alternatively, a telescope of the first optical communications terminal 102 may include one or more mirrors. The one or more mirrors may be used in addition to or as an alternative to the lenses of either the Keplerian telescope or the Galilean telescope.

### Example Methods

When transmitting and receiving optical communications beams, the first optical communications terminal 102 may be aligned with one or more remote optical communications terminals. To align the FOV with one or more remote optical communications terminals, the movable PIC assembly of the first optical communications terminal 102 may be moved and/or rotated.

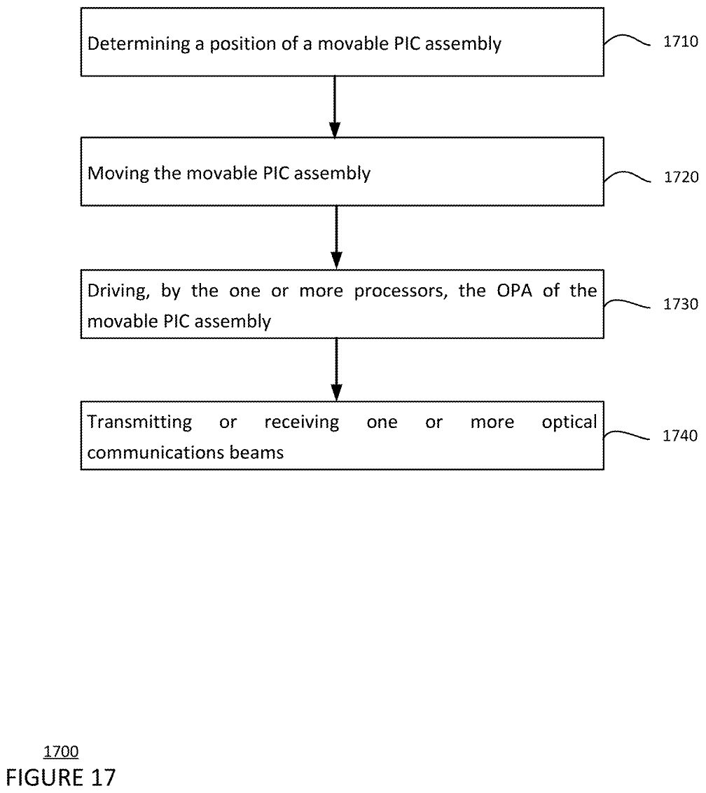

In this regard, the OPA of the movable PIC assembly 510,610,710,810,910,1010,1110,1210,1310,1410 may be configured to transmit and receive optical communications beams. FIG. 17 illustrates an example method 1700 of transmitting or receiving one or more optical communications beams via an OPA of a movable PIC assembly. At block 1710, the method includes determining a position of a movable PIC assembly. In this regard, the position of the movable PIC assembly 510,610,710,810,910,1010,1110,1210,1310,1410 may be determined during acquisition based on a location of the one or more remote optical communications terminals. The location of the remote optical communications terminal may be determined based on a scan of the FOR of the first optical communications terminal, historical or known locations of the one or more remote optical communications terminals, one or more readings from one or more sensors of the first optical communications terminal, a determination of the location of the one or more remote optical communications terminals (e.g., algorithmic extrapolation), or any combination thereof.

At block 1720, the method 1700 further includes moving the movable PIC assembly. The movable PIC assembly 510,610,710,810,910,1010,1110,1210,1310,1410 may be positioned such that one or more remote optical communications terminals or client devices is within the FOV of the first optical communications terminal. In this regard, the movable PIC assembly 510,610,710,810,910,1010,1110,1210,1310,1410 be may be positioned such that optical communications beams from the OPA of the first optical communications terminal 102 may be transmitted to the one or more remote optical communications terminals. Similarly, the movable PIC assembly may be positioned such that the one or more optical communications beams to the OPA of the first optical communications terminal may be received from the one or more remote optical communications terminals. In order to transmit and receive one or more optical communications beams, the movable PIC assembly 510,610,710,810,910,1010,1110,1210,1310,1410 may be positioned such that one or more remote optical communications terminals or client devices is within the FOV of the first optical communications terminal 102. The movable PIC assembly may be moved in accordance with the method 1800, discussed below.

At block 1730, the method may further include driving, by the one or more processors, the OPA of the movable PIC assembly. In this regard, the OPA of the movable PIC assembly 510,610,710,810,910,1010,1110,1210,1310,1410 may be driven to achieve a precise pointing direction corresponding to the one or more remote optical communications terminals. To drive the OPA, the one or more processors of the first optical communications terminal may modify or shift the phasing of one or more elements of the OPA. The one or more processors of the first optical communications terminal may calculate a shift for each phase shifter in a plurality of phase shifters of the OPA to achieve the precise desired pointing direction beam. This may also be individual activation of elements, similar to Focal Plane Array behavior.

At block 1740, the method 1700 further includes transmitting or receiving one or more optical communications beams. In this regard, the first optical communications terminal 102 may transmit and receive optical one or more optical communications beams via the OPA of the movable PIC assembly 510,610,710,810,910,1010,1110,1210,1310,1410. Using the optical communication beams, the one or more processors may establish a communication link with the one or more remote optical communications terminals or transfer data.

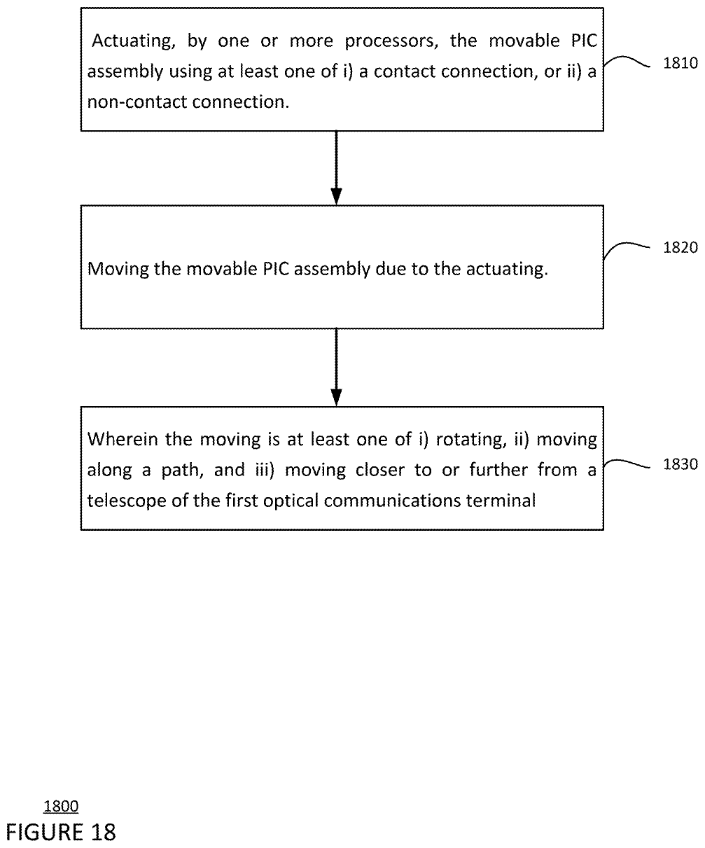

FIG. 18 illustrates an example method 1800 of moving a movable photonics integrated circuit (PIC) assembly comprising an optical phased array (OPA) of a first optical communications terminal. For example, at block 1810 the method 1800 includes actuating, by one or more processors, the movable PIC assembly using at least one of i) a contact connection, or ii) a non-contact connection. In one instance, the actuating may use a contact connection. In this regard, the actuating may include actuating, by one or more processors, a movable component 520,620,720,920,1020. Additionally or alternatively, the actuating may include actuating, by one or more processors, one or more actuators 530,630,1030a, 1030b. Additionally or alternatively, in one instance, the actuating may use a non-contact connection. In this regard, the actuating may include changing a magnetic field. Additionally or alternatively, the actuating may include changing an electrostatic field. At block 1820, the method includes moving the movable PIC assembly due to the actuating. The actuation allowing for the movement of the movable PIC assembly 510,610,710,810,910,1110,1210,1310,1410. In some implementations, the movement may be about the movable component due to the actuating. In this regard, the one or more actuators 530,630,1030a, 1030b and/or the movable component 520,620,720,920,1020 coupled to the movable PIC assembly 510,610,710,810,910,1110,1210,1310,1410 0 may be actuated. Additionally or alternatively, the movement of the movable PIC assembly 510,610,710,810,910,1110,1210,1310,1410 may be moved with respect to a surface 812 due to the selective magnetizing of the surface, the movable PIC assembly, or both.

At block 1830, the method 1800 further states wherein the moving is at least one of i) rotating, ii) moving along a path, and iii) moving closer to or further from a telescope of the first optical communications terminal. In one example, the movable PIC assembly may be rotated such that the first optical communications terminal 102 may transmit and receive one or more optical communications beams with the one or more remote optical communications terminals. In some instances, moving may include rotating the movable PIC assembly 510,610,810,910,1010,1210,1310. In some instances, the movable PIC assembly 510,610,810,910,1010,1210,1310 may be rotated about the movable component 520,620,920,1020 (e.g., one or more axes of the movable component). In some instances, the movement of the movable PIC assembly may be in the x and y planes. The rotation of the movable PIC assembly may be such that the FOV of the first optical communications terminal 102 differs at each position. In one instance, the rotation of the movable PIC assembly 510,610,810,910,1010,1210 may be such that the center of the movable PIC assembly 510,610,810,910,1010,1210 is not displaced when rotated. In another instance, the rotation of the movable PIC assembly 510,610,810,910,1010,1310 may be such that the center of the movable PIC assembly 510,610,810,910,1010,1310 is displaced by an angle θ and a distance D during rotation

In another example, the movable PIC assembly may move along a path (e.g., an arc-shape path, a bowl-shaped path, an arbitrarily-shaped path) such that the first optical communications terminal 102 may transmit and receive one or more optical communications beams with the one or more remote optical communications terminals. In this regard, the movable PIC assembly 710,1310 may be moved along the path. In some instances, the movable PIC assembly may be moved along the path about the movable component 720. In some instances, the path may be an arc-shaped path which may form a portion of the circumference of a circle. In one example, the center of the circle may be the center of the movable component 720. In another instance, the path may be a bowl-shaped path which may form a portion of a sphere. In one example, the center of the sphere may be the center of the movable component 720.

Additionally or alternatively, in some instances, the movable PIC assembly 510,610,710,810,910,1010,1210,1310,1410 may be moved with respect to the telescope of the first optical communication terminal 102. In some implementations, the movable PIC assembly 510,610,710,810,910,1010,1210,1310,1410 may be moved along an optical axis of the telescope of the first optical communications terminal. The movable PIC assembly 510,610,710,810,910,1010,1210,1310,1410 may be moved to change beam divergence. This may be used for easier acquisition, higher tracking performance during large disturbances, etc.

The features and methodology described herein may provide a communication system containing optical communications terminals with a configurable FOV. The configurable FOVs may allow an optical communications terminal to be aligned with one or more remote optical communications terminals across a larger FOR. In this regard, such communication systems require less materials to construct and are easier to maintain overall. Additionally, the individual optical communications terminals may require fewer precision surfaces (e.g., may not require an internal steering mirror). In this regard, the internal components of the optical communications terminal may require less actuation overall to allow for a desired bandwidth. Moreover, as an optical communications beam may be directed from the telescope to movable PIC assembly without other precision surfaces, the architecture reduces dispersion and/or dissipation. As such, a narrower beam with lower power and less volume may be used to maintain connectivity and connection quality. Such a design allows for less complexity and fewer materials.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
a first optical communications terminal comprising:
a telescope comprising one or more lenses;
a movable photonics integrated circuit (PIC) assembly positioned relative to the telescope comprising an optical phased array (OPA); and
one or more processors configured to move the movable PIC assembly;
wherein the moveable PIC assembly is configured to move by at least one of i) rotating, or ii) moving along a path, and iii) moving closer to or further from a telescope of the first optical communications terminal.

2. The system of claim 1, wherein the first optical communications terminal further includes one or more magnets coupled to the movable PIC assembly.

3. The system of claim 2, wherein the first optical communications terminal further includes a surface, the surface configured to be selectively magnetized.

4. The system of claim 1, wherein the first optical communications terminal further includes:
one or more actuators coupled to the movable PIC assembly; and
a movable component coupled to the movable PIC assembly and configured to allow for movement of the movable PIC assembly.

5. The system of claim 4, wherein the movable PIC assembly is configured to move about the movable component.

6. The system of claim 4, wherein the one or more actuators are a first actuator and a second actuator and the first actuator is disposed on an edge of the movable PIC assembly opposite the second actuator.

7. The system of claim 4, wherein the movable component may be used in conjunction with a movable component actuator and the one or more actuators move faster than the movable component actuator.

8. The system of claim 4, wherein the first optical communications terminal further comprises an arm structure, the arm structure coupled to the movable PIC assembly and the movable component such that the arm structure is arranged perpendicular or approximately perpendicular to the movable PIC assembly.

9. The system of claim 1, further comprising a second optical communications terminal.

10. The system of claim 1, wherein the first optical communications terminal further includes one or more heat straps coupled to the movable PIC assembly and wherein the one or more heat straps have an elasticity such that the movable PIC assembly may move within an expected performance envelope.

11. The system of claim 1, wherein the movable PIC assembly further includes a thermal base configured to evenly distribute heat away from the movable PIC assembly.

12. The system of claim 1, wherein the first optical communications terminal further includes a cable.

13. The system of claim 1, wherein the telescope is a Keplerian telescope.

14. The system of claim 1, wherein the telescope is a Galilean telescope.

15. The system of claim 1, wherein the movable PIC assembly is positioned at a plane relative to the telescope and wherein the plane is an exit pupil of the telescope.

16. A method of moving a movable photonics integrated circuit (PIC) assembly comprising an optical phased array (OPA) of a first optical communications terminal, the method comprising:
actuating, by one or more processors, the movable PIC assembly using at least one of i) a contact connection, or ii) a non-contact connection; and
moving the movable PIC assembly due to the actuating;
wherein the moving is at least one of i) rotating, ii) moving along a path, and iii) moving closer to or further from a telescope of the first optical communications terminal.

17. The method of claim 16, wherein:
the moving is rotating; and
the moving includes displacing a center of the movable PIC assembly by an angle and a distance.

18. The method of claim 16, wherein:
the moving is rotating; and
the moving does not include displacing a center of the movable PIC assembly.

19. The method of claim 16, wherein:
the moving is moving along the path, wherein the path is an arc-shaped path; and
the arc-shaped path forms a portion of a circumference of a circle.

20. The method of claim 19, wherein a center of the circle is a center of a movable component.

21. The method of claim 16, wherein:
the moving is moving along the path, wherein the path is a bowl-shaped path; and
the bowl-shaped path forms a portion of a sphere.

22. The method of claim 21, wherein a center of the sphere is a center of a movable component.

23. The method of claim 16, wherein:
the moving is moving closer to or further from the telescope of the first optical communications terminal; and
the moving is along an optical axis of the telescope of the first optical communications terminal.

24. The method of claim 16, wherein the moving is about a movable component.
